(19) United States
(12) Patent Application Publication
(10) Pub. No.: US 2024/0402139 A1
(43) Pub. Date: Dec. 5, 2024

(54) VARYING THE COUPLANT OR RATIO OF MIXTURES INSIDE OR OUTSIDE OF AN ENCLOSED OR OPEN NON-DESTRUCTIVE TESTING DEVICE

(71) Applicant: University of South Florida, Tampa, FL (US)

(72) Inventor: Jose Paul, Tampa, FL (US)

(21) Appl. No.: 18/678,124

(22) Filed: May 30, 2024

Related U.S. Application Data
(60) Provisional application No. 63/504,852, filed on May 30, 2023.

(51) Int. Cl. G01N 29/28; G01N 29/04

(52) U.S. Cl. CPC G01N 29/28; G01N 29/04

(57) ABSTRACT

Disclosed herein is a testing device comprising a housing, a first couplant agent, and a transducer disposed in the housing, wherein the housing has a proximal end and a distal end; and a packaging material having a proximal end and a distal end, wherein the proximal end of the packaging material is coupled to the distal end of the housing to form a first interface. The first couplant includes two or more components, of which the ratio of the components is varied to decrease an acoustic impedance mismatch. The device may further have a second couplant disposed on the distal end of the packaging material, which is in contact with a testing material. A method of use of the testing device is also disclosed.

### CROSS REFERENCE TO RELATED APPLICATIONS

This patent application claims priority to, and the benefit of, U.S. provisional application, U.S. 63/504,852, filed on May 30, 2023, which is hereby incorporated by reference herein in its entirety.

### BACKGROUND

In light of advancements in the art of acoustics, the discipline of nondestructive monitoring of structural health has advanced. Immersion testing, in which a sample is immersed in a tank of liquid couplant, has been extensively used to evaluate any potential faults in a particular structural component or sample. This is very beneficial for detecting the location of fractures in composites, if not delamination or any other faults or discontinuities.

In contrast to X-ray based methods, Eddy current, electron probes, or any other similar nondestructive techniques, ultrasound probes or acoustics allow for the capture of information from greater depths inside materials. Additional acoustic techniques include transmission mode or pulse echo mode with fewer transducers.

When a packaging material is selected for a degree of impedance match to transmit and/or receive signals of maximum possible intensity into a specimen, the range of measurable impedance of the specimen is narrow and is limited by the matching mechanism and selected packaging material and is usually done with one specific couplant. Although this technique works on paper, in practice, the acoustic impedance of a specimen may vary depending on the processes that a specimen experienced (e.g. external pressures, physical forces, chemical forces, etc). The hardware of an immersion tester yields useless when observing specimen with impedance that falls above or below the margin of the hardware. Recently developed ultrasound wheels for ultrasound testing are made once with a specific material.

Theoretically, transit signal loss may be roughly categorized into two categories, reflection losses the attenuation losses. Both of which need to be accounted for in the development of ultrasound probes.

### SUMMARY

Disclosed herein are enclosed devices, such as a wheel for agility or any other enclosed device containing a couplant. Use of the closed device system closely mimics immersion testing while eliminating the need for complete immersion of the sample, which may be on site or too large to fit in a tank. The disclosed device and method are a solution to the need for the same hardware (e.g. same packaging material) to be used for a larger range of impedance by changing the couplant for varying specimen by alternating the couplant or proportions of component of the couplant to ideally match the specimen's impedance. By varying the acoustic impedance of couplant in the ultrasound wheel equipment, signal quality can be improved, especially in closed structures. The couplant may be used inside and/or outside the equipment.

When using an enclosed device for immersion testing, a transducer signal travels through the couplant, through the enclosure made of a packaging material, and into the sample of interest-when using a pulse echo technique, the signal traverses the path in reverse. Reflection occurs due to the mismatch in acoustic impedance between materials. Specific acoustic impedance is a material property, and it can be approximated as the product of density of a medium and the sound propagation speed. A significant mismatch in specific acoustic impedance of interacting media at boundaries results in increased reflection losses and lower signal transmission at these interfaces.

An exemplary device is disclosed that accounts for both reflection and attenuation losses and a method is disclosed for achieving a balance between the losses in order to facilitate the separation of important signal pulses for post-processing.

The exemplary device improves the range over which an ultrasonic testing device can operate, provided the selection of packaging material. The choice of packaging material usually puts a hard limit on the range where usable signal strength is received in the specimen and/or receiver both in pulse echo mode and when a separate receiver is used.

In some aspects, a testing device is described. The testing device includes a housing including a first couplant agent and a transducer, wherein the housing has a proximal end and a distal end; and a packaging material having a proximal end and a distal end, wherein the proximal end of the packaging material is coupled to the distal end of the housing to form a first interface; wherein the test material has a first surface and an opposite second surface; wherein a second interface is formed between the first surface of the test material and the distal end of the packaging material during testing; and wherein an acoustic impedance mismatch between the first couplant agent and the packaging material is less than or equal to an acoustic impedance mismatch between packaging material and test material.

In some aspects, the first couplant agent includes water, glycerin, castor oil, ethylene glycol, kerosene, honey, glycerol, propylene glycol, sugar solution, solid liquid solution system, or a combination thereof.

In some aspects, the first couplant agent is a mixture of two or more fluids, gels, or solid in liquid solutions, wherein a ratio of two or more fluids, gels, or solid in liquid solutions is varied.

In some aspects, the testing device further includes a second couplant agent applied to the distal end of the packaging material during testing such that it is disposed at the second interface.

In some aspects, the second couplant agent includes at least one of the two or more fluids, gels, or solid in liquid solutions present in the first couplant agent.

In some aspects, the second couplant agent has an acoustic impedance substantially identical to an acoustic impedance of the packaging material.

In some aspects, an acoustic reflection from the first interface is less than about 65 percent with respect to the reflection from the second interface.

In some aspects, the packaging material has a thickness of about ½ to about ¼ of a transmitted wavelength or any multiple thereof.

In some aspects, the packaging material includes polyurethane, polystyrene, polybutadiene, silicon, polyethylene, polypropylene, rubber, nylon, polycarbonate, acrylic, araldite, or any combination thereof.

In some aspects, the first couplant agents and second couplant agents are exchangeable.

In some aspects, the testing device is in electrical communication with a control unit.

In some aspects, the test material includes a metal, a liquid, a gel, a polymer, a concrete, or any combination thereof.

In some aspects, the testing device comprises two transducers.

In some aspects, a method of determining one or more properties of a test material is described. The method may include: (a) contacting a testing device, the testing device including: a housing including a first couplant agent and a transducer, wherein the housing has a proximal end and a distal end; a packaging material having a proximal end and a distal end, wherein the proximal end of the packaging material is coupled to the distal end of the housing to form a first interface; wherein the test material has a first surface and an opposite second surface; such that a second interface is formed between the first surface of the test material and the distal end of the packaging material; (b) measuring an acoustic signal transmitted or reflected by the test material; and (c) correlating the acoustic signal with the one or more properties of the test material.

In some aspects, the testing device exhibits an acoustic impedance mismatch of 45 Mega Rayls or less between an acoustic impedance of the first couplant agent and an acoustic impedance of the packaging material.

In some aspects, the first couplant agent is a mixture of two or more fluids, gels, or solid in liquid solutions.

In some aspects, the method further includes varying a ratio of two or more fluids, gels, or solid in liquid solutions to achieve an acoustic impedance mismatch of 30% between an acoustic impedance of the first couplant agent and an acoustic impedance of the packaging material.

In some aspects the method further includes applying a second couplant agent at the distal end of the packaging material to form a layer of the second couplant agent at the second interface.

In some aspects, the second couplant agent includes at least one of the two or more fluids, gels, or solid in liquid solutions of the first couplant agent.

In some aspects, the second couplant agent has an acoustic impedance substantially identical to an acoustic impedance of the packaging material.

In some aspects, an acoustic reflection from the first interface is less than about 65% with respect to the reflection from sample device interface, and wherein an acoustic reflection from the second surface of the test material is greater than about 30% of a magnitude of reflection from acoustic reflection from the first interface.

In some aspects, the one or more properties include defects, surface roughness, density estimate, speed of sound, temperature estimate, acoustic impedance estimate, time of flight, or any combination thereof.

In some aspects, contacting a testing device comprises contacting two or more testing devices.

### BRIEF DESCRIPTION OF THE DRAWINGS

The skilled person in the art will understand that the drawings described below are for illustration purposes only.

FIG. 1 shows a schematic of an experimental setup, reflections from marked surfaces have the corresponding subscript.

FIG. 2 shows a ray diagram of sound interaction at couplant-packaging material-sample interface during oblique incidence.

FIG. 3 shows a comparison of amplitude Aₛ in time domain for 0%, 10% and 45% by mass glycerin content in couplant.

FIG. 4 shows results of the percentage improvement in Aₛ and A_{d} while varying the mass proportions of glycerin in the couplant.

FIG. 5 shows results of noise and SNR evaluated for Aₛ in all measurements with varying glycerin proportions.

FIG. 6 shows results of gain in Aₛ and A_{d} as the proportion of glycerin in couplant vary (calculated with respect to A_{sw} and A_{dw} respectively).

FIG. 7 shows results of the ratio of speed of sound in couplant mixtures to DI water at 25° C.

FIG. 8 shows results of bandwidth at FQHM as the glycerin proportion in couplant vary.

FIG. 9 shows a comparison of transmission coefficient with respect to sample acoustic impedance perfectly matched packaging material and engineered materials provided same couplant.

FIG. 10 shows signal output, A: Water alone as couplant, B: Glycerin in water 4:3 ratio by mass. (Acrylic disc of 1 cm thickness was the sample in both cases).

FIG. 11 shows the signal to noise ratio for experiments A and B.

### DETAILED DESCRIPTION

Some references, which may include various patents, patent applications, and publications, are cited in a reference list and discussed in the disclosure provided herein. The citation and/or discussion of such references is provided merely to clarify the description of the present disclosure and is not an admission that any such reference is “prior art” to any aspects of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The expressions “ambient temperature” and “room temperature” as used herein are understood in the art and refer generally to a temperature from about 20° C. to about 35° C.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell” refers to a reference composition, article, or an electrochemical cell comprising substantially identical components and wherein an inventive component is substituted with a common in the art component.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention nor the claims which follow.

While aspects can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

In view of the described device and methods, herein below are described more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

The present invention may be understood more readily by reference to the following detailed description of various aspects of the invention and the examples included therein and to the Figures and their previous and following description.

An immersion transducer is a type of acoustic transducer designed to operate in immersion or liquid-coupled environments. These transducers are used in various applications where it's necessary to transmit and receive acoustic waves through a liquid medium, such as water or gel.¹⁻⁴ Immersion transducers are widely employed in fields such as medical ultrasound imaging, non-destructive testing (NDT), underwater sonar, and industrial inspection.³⁻⁵

Immersion transducers or partially immersed transducers are typically constructed with waterproof materials and encapsulation techniques to withstand prolonged exposure to liquid environments without degradation or damage.⁵⁻⁷ They require a coupling medium, such as water or gel, to ensure efficient transmission of acoustic waves between the transducer and the target object or medium. The coupling medium helps to minimize signal loss and reflections at the interface, allowing for accurate imaging or detection.

Additionally, immersion transducers are often designed to operate over a wide frequency range to accommodate various applications, from low-frequency underwater sonar to high-frequency medical ultrasound imaging. They are engineered for high sensitivity to detect subtle variations in acoustic signals, making them suitable for applications requiring precise imaging or defect detection.

Depending on the application, immersion transducers may have focused or broad acoustic beams to achieve specific imaging or detection requirements. Focused beams are used for precise imaging of targets at specific depths, while broad beams are suitable for wide-area coverage. Immersion transducers may also be configured as array transducers, with multiple individual elements arranged in linear, phased, or matrix configurations.³ Array transducers offer enhanced imaging capabilities, such as beam steering, focusing, and multi-angle imaging.

The importance of immersion transducers in acoustics stems from their ability to facilitate accurate and reliable acoustic measurements, imaging, and inspection in liquid-coupled environments. Some key applications where immersion transducers play a crucial role include medical ultrasound imaging, non-destructive testing (NDT), underwater sonar, and material characterization.

Immersion transducers are extensively used in medical ultrasound imaging for visualizing internal organs, tissues, and structures in the human body. The immersion transducers enable non-invasive diagnostic imaging with high resolution and real-time imaging capabilities.⁷

In industrial applications, immersion transducers are employed for NDT purposes to detect defects, cracks, or irregularities in materials such as metals, plastics, and composites.⁸⁻¹¹ Use of an immersion transducer in NDT ensures the structural integrity and quality of components, pipelines, and structures without causing damage.

In underwater sonar systems, immersion transducers are essential for navigation, object detection, and communication in marine environments. The immersion transducers enable the detection of underwater obstacles, marine life, and underwater vehicles with high precision and sensitivity.¹²⁻¹⁷

In material characterization applications, immersion transducers analyze the acoustic properties of materials, such as elasticity, density, and thickness.¹⁸⁻¹⁹ The immersion transducers are employed in research, development, and quality control processes across various industries.²⁰

The versatility, sensitivity, and reliability of immersion transducers make them indispensable tools in acoustic imaging, detection, and measurement. Immersion transducers offer several advantages over other types of transducers, particularly in applications that involve liquid-coupled environments such as medical ultrasound imaging, underwater sonar, and NDT. Some of the key advantages of immersion transducers include enhanced signal transmission efficiency, improved acoustic coupling, reduced signal attenuation, improved sensitivity and resolution, versatility in applications, and compatibility with ultrasound couplants.

Immersion transducers utilize a liquid coupling medium, such as water or gel, to facilitate efficient transmission of acoustic waves between the transducer and the target object or medium. This liquid coupling helps to minimize signal loss and reflections at the interface, resulting in improved signal transmission efficiency compared to air-coupled transducers.

The use of a liquid coupling medium provides better acoustic coupling between the transducer and the target medium, leading to more accurate and reliable imaging or detection. This enhanced acoustic coupling helps to minimize acoustic impedance mismatches and ensures optimal energy transfer, resulting in clearer and more detailed acoustic images or signals.

Immersion transducers experience less signal attenuation compared to air-coupled transducers, particularly at higher frequencies. The liquid coupling medium helps to reduce the attenuation of acoustic waves as they propagate through the medium, allowing for longer transmission distances and deeper penetration into the target material or medium.

Immersion transducers are often designed for high sensitivity and resolution, making them suitable for applications requiring precise imaging or defect detection. The efficient transmission of acoustic waves through the liquid coupling medium enables the transducer to capture subtle variations in acoustic signals with greater sensitivity and resolution.

Immersion transducers are versatile and can be used in a wide range of applications, including medical imaging, NDT, underwater sonar, and material characterization. Their ability to operate effectively in liquid-coupled environments makes them suitable for various industries and research fields where accurate acoustic measurements or imaging are required.

Immersion transducers are compatible with a variety of ultrasound couplants, such as water, glycerin, or gel, which are commonly used to improve acoustic coupling between the transducer and the target medium. This compatibility allows for flexibility in coupling medium selection based on the specific application requirements.

In addition to immersion transducers, there are several other types of transducers used in acoustics and ultrasonics, each with its own characteristics, advantages, and applications. Some of the common types of transducers include: air-coupled transducers, contact transducers, and impedance matching.

Air-coupled transducers, which operate in air and are used when direct contact with the target medium is not feasible or desirable. They are commonly employed in applications such as airborne ultrasonics, where they generate and receive ultrasonic waves through the air. Air-coupled transducers are often used in non-contact measurement and inspection applications, such as measuring material thickness or detecting flaws in composite materials.²¹

Contact transducers, also known as direct-contact or dry-coupled transducers, are designed to make direct contact with the surface of the target material or medium without the need for a coupling medium. They are commonly used in applications such as thickness gauging, flaw detection, and material characterization, where high-resolution measurements and precise acoustic coupling are required. Contact transducers are particularly suitable for inspecting solid materials, such as metals, plastics, and composites.¹

The selection of the appropriate transducer depends on factors such as the application requirements, operating environment, desired performance parameters, and budget constraints.

Impedance matching is essential in acoustic transducer technology to maximize the transfer of acoustic energy between different media, such as between a transducer and the material being tested or imaged. The primary need for impedance matching arises from the desire to minimize signal reflections and maximize the efficiency of acoustic energy transmission and reception.²²⁻²⁸ Effective impedance matching ensures that a greater portion of the acoustic energy is transmitted into the target material or medium, leading to improved sensitivity, resolution, and signal-to-noise ratio in applications such as medical imaging, non-destructive testing, and underwater sonar.

Several techniques are employed to achieve impedance matching in acoustic transducer systems. Some of the commonly used techniques include acoustic matching layers, tapered transducer design, quarter-wave matching, acoustic lens design, phased array techniques, and electrical matching networks.

Acoustic matching layers are thin intermediate layers placed between the transducer and the target medium to minimize impedance mismatch. These layers are designed to have intermediate acoustic impedance values that facilitate smooth transmission of acoustic energy across the interface. Matching layers can be made of materials such as polymers, ceramics, or composites, carefully chosen to provide optimal impedance matching.^{22-25,29}

Tapered transducer designs involve gradually varying the thickness or acoustic impedance of the transducer element to achieve impedance matching with the target medium. Tapering the transducer element helps to reduce signal reflections and improve energy transmission efficiency by gradually transitioning from the high impedance of the transducer to the lower impedance of the target medium.³⁰

Quarter-wave matching techniques involve the use of quarter-wavelength matching layers or materials to achieve impedance matching. By carefully selecting the thickness and acoustic properties of the matching layer, it is possible to create a quarter-wavelength layer that effectively cancels out reflections at the interface between the transducer and the target medium.

Acoustic lenses are used to focus or collimate acoustic waves and can also be designed to provide impedance matching between the transducer and the target medium. By carefully shaping the lens material and controlling its acoustic properties, it is possible to achieve impedance matching and improve energy transmission efficiency.

Phased array transducer systems utilize multiple transducer elements controlled by electronic phase shifting to steer and focus acoustic beams. By adjusting the phase relationships between the individual transducer elements, phased array systems can effectively control the impedance matching at different points within the acoustic field, leading to improved imaging resolution and sensitivity.^{31,32}

In some cases, impedance matching can also be achieved using electrical matching networks, such as impedance transformers or matching circuits, placed between the transducer and the electronics. These networks adjust the electrical impedance of the transducer to match the impedance of the electronics or the target medium, thereby optimizing energy transfer and signal reception.⁶

Impedance matching techniques are crucial for optimizing the performance of acoustic transducer systems in various applications. By minimizing signal reflections and maximizing energy transmission efficiency, impedance matching enhances the sensitivity, resolution, and overall effectiveness of acoustic devices for imaging, sensing, and communication purposes.

Acoustic matching layers are thin intermediate layers positioned between the acoustic transducer and the medium being tested or imaged. These layers serve to minimize impedance mismatches between the transducer and the target medium, thereby enhancing the transmission and reception of acoustic energy.

Acoustic matching layers can be categorized into several subcategories based on their design, composition, and function. Some common subcategories include single-layer matching, graduated matching layers, multilayer matching, resonant matching layers, and frequency-selective matching layers.

Single-layer matching involves the use of a single intermediate layer positioned between the transducer and the target medium. The material properties of the matching layer are carefully selected to achieve impedance matching with both the transducer and the target medium.^{33,34} Single-layer matching layers are relatively simple in design but can effectively reduce signal reflections and improve energy transmission efficiency.

Graduated matching layers, also known as gradient matching layers, involve the use of a layer with gradually varying acoustic properties to achieve impedance matching. The thickness or composition of the matching layer is varied across its surface to create a smooth transition from the high impedance of the transducer to the lower impedance of the target medium. Graduated matching layers are particularly useful for minimizing reflections and maximizing energy transmission efficiency in applications where precise impedance matching is critical.

Multilayer matching involves the use of multiple intermediate layers with different acoustic properties stacked together to achieve impedance matching. Each layer is designed to contribute to the overall impedance matching process, with the combination of layers providing a tailored impedance profile that minimizes reflections and optimizes energy transmission. Multilayer matching can offer greater flexibility and control over the impedance matching process, allowing for enhanced performance in demanding applications.^{6,33,34}

Resonant matching layers utilize the phenomenon of acoustic resonance to achieve impedance matching at specific frequencies of interest. These layers are designed to resonate at or near the operating frequency of the transducer, effectively canceling out reflections and maximizing energy transmission efficiency at that frequency. Resonant matching layers are particularly useful in applications where a narrowband response is desired, such as in medical ultrasound imaging or ultrasonic flaw detection.^{35,36}

Frequency-selective matching layers are designed to provide impedance matching only within a specific frequency range, while exhibiting mismatched impedance outside that range. These layers are useful for applications where broadband impedance matching is not required, allowing for efficient energy transmission and reception within the desired frequency band while minimizing interference from out-of-band signals.³⁶

Acoustic matching layers play a crucial role in optimizing the performance of acoustic transducer systems by minimizing signal reflections and maximizing energy transmission efficiency. By carefully selecting and designing matching layers to suit the specific requirements of the application, improved sensitivity, resolution, and overall effectiveness can be achieved in acoustic imaging, sensing, communication applications among other applications.

Acoustic matching layers used on immersion transducers are critical components that facilitate efficient transmission and reception of acoustic waves across the interface between the transducer and the immersion medium, such as water or gel. The choice of matching layer depends on various factors, including the operating frequency, desired bandwidth, material properties, and specific application requirements. Below is an elaborate description of various matching layers commonly used on immersion transducers and the factors influencing their selection.

Polymer matching layers are widely used in immersion transducers due to their versatility, ease of fabrication, and compatibility with a wide range of frequencies. Common polymer materials used include polyvinylidene fluoride (PVDF), polyurethane, and epoxy resins. Polymer matching layers can be tailored to achieve specific acoustic impedance values by adjusting factors such as thickness, density, and composition. The choice of polymer matching layer depends on factors such as the operating frequency range, desired bandwidth, acoustic impedance of the transducer material, and compatibility with the immersion medium.

Ceramic matching layers are preferred for high-frequency immersion transducers, typically operating in the MHz range. Piezoelectric ceramics such as lead zirconate titanate (PZT) or lithium niobate (LiNbO₃) are commonly used due to their high acoustic impedance and excellent piezoelectric properties.⁶ Ceramic matching layers are designed to have a thickness corresponding to a quarter-wavelength at the operating frequency to achieve optimal impedance matching.

Composite matching layers combine different materials, such as polymers and ceramics, to achieve specific acoustic properties and impedance matching characteristics. Layered composites or composite films can be designed with tailored acoustic impedance profiles to optimize energy transmission and reception. Composite matching layers offer versatility and flexibility in achieving impedance matching across a wide range of frequencies and applications. Metals may be used in certain conditions as matching layer.

The choice of matching layer depends on the frequency range of the transducer, with different materials and designs optimized for specific frequency bands. The desired bandwidth of the transducer system influences the selection of matching layer materials and designs to achieve optimal performance across the frequency spectrum. Matching layers are selected to achieve impedance matching between the transducer and the immersion medium, minimizing signal reflections and maximizing energy transmission efficiency.

The choice of matching layer material should consider factors such as chemical compatibility, stability, and acoustic properties with respect to the immersion medium (e.g., water, gel). Design and configuration of the transducer, including elements such as shape, size, and geometry, influence the choice of matching layer to optimize acoustic performance and signal characteristics.

Herein, an exemplary immersion transducer device is described. The exemplary immersion transducer device includes an enclosure of the transducer, such as a wheel for agility or any other enclosed form containing a couplant. The couplant closely mimics immersion testing while eliminating the need for complete immersion of the sample, which may be on site or too large to fit in a processing tank.

The exemplary immersion transducer device has a peripheral cover/surface, which is herein referred to as packaging material. The packaging material houses the liquid couplant and transducer within. The packing material might be used for multiple surfaces or at the point of contact between the exemplary device and a sample, by treating the packaging material as an acoustic matching layer. However, in the exemplary device, matching between the couplant contained in packaging material acts and the sample of interest. The couplant composition in the packaging material can be varied to achieve optimal impedence matching with the sample rather than changing the composition of the packaging material. A packaging material may be chosen that fulfills certain criteria. A packaging material preferably maximizes throughput of signal into the sample with minimal interference with the reflections from sample. A packaging material preferably allows for ease of signal differentiation.

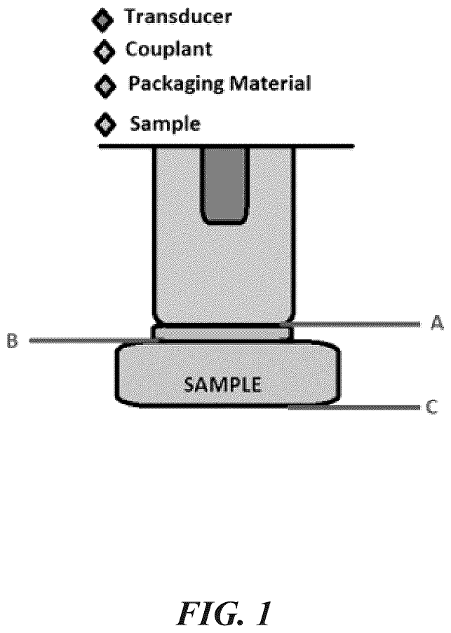

Signal loss during transmission may be roughly categorized into mode conversion losses, reflective losses and attenuation losses. Mode conversion losses are neglected due to normal incidence assumption. Reflection losses occur at the transducer-couplant interface, followed by the reflection at couplant-packaging material interface (interface A of FIG. 1) and reflection at packaging material sample interface (interface B of FIG. 1), and finally by attenuation within the couplant enclosed in the device. The couplant column may be enlarged to serve as a buffer layer by acting as a delay line and protection of the transducer from elements in addition to its function as an impedance matched couplant.

In the state-of-the-art, the matching layer in the transducer has a characteristic acoustic impedance between that of the active element (such as a piezo electric crystal) and the couplant material of choice, usually water. The transducer matching layer in conventional immersion transducers are made by altering the density of polymers by addition of inert ceramic particle loading and then the transducer matching layer is fixed. For a given choice of transducer matching layer, the signal transmission through the packaging material of the device can be improved by raising the acoustic impedance of the couplant in the device to reduce the disparity in acoustic impedance between the matching layer and couplant as well as the couplant and packaging material. Both of these outcomes can be achieved by introducing fine-tuned couplant blends of miscible fluids for impedance matching. For sound travelling from medium 1 to medium 2, reflection (R) and transmission (T) coefficients assuming normal incidence are calculated as follows:

$$\\ \begin{matrix}R = \frac{{Z}_{2} - {Z}_{1}}{{Z}_{2} + {Z}_{1}} & ( 1 )\end{matrix}$$

$$\\ \begin{matrix}T = \frac{2 {Z}_{2}}{{Z}_{2} + {Z}_{1}} & ( 2 )\end{matrix}$$

where Z₁ and Z₂ are the specific acoustic impedance of medium 1 and medium 2 respectively.

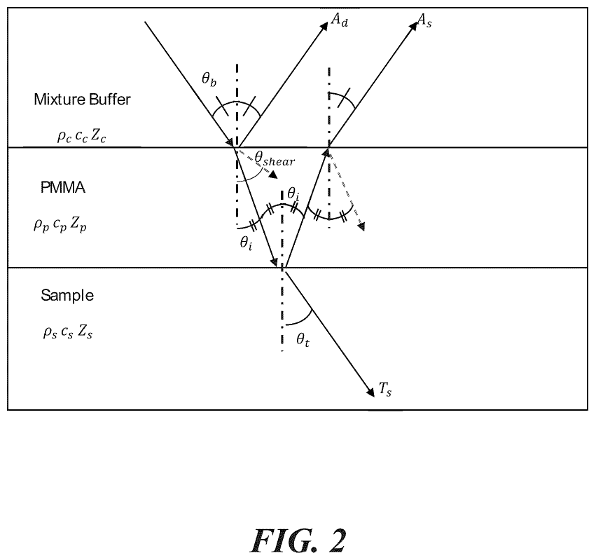

Let Z_{T}, Z_{c} and Zₚ be the specific acoustic impedance of transducer matching layer, couplant, and packaging material, respectively. Therefore, the net reflection loss coefficient at interface B in FIG. 1, corresponding to the PMMA-sample interface in FIG. 2 is:

$$\\ \begin{matrix}{R}_{net} = \frac{{Z}_{c} - {Z}_{T}}{{Z}_{c} + {Z}_{T}} \frac{{Z}_{p} - {Z}_{c}}{{Z}_{p} + {Z}_{c}} \frac{{Z}_{s} - {Z}_{p}}{{Z}_{s} + {Z}_{p}} & ( 3 )\end{matrix}$$

The net transmission coefficient at interface B in FIG. 1 is:

$$\\ \begin{matrix}{T}_{net} = \frac{2 {Z}_{c}}{{Z}_{c} + {Z}_{T}} \frac{2 {Z}_{p}}{{Z}_{p} + {Z}_{c}} \frac{2 {Z}_{s}}{{Z}_{p} + {Z}_{s}} & ( 4 )\end{matrix}$$

Rₙₑₜ is minimized when the following criteria is met:

$$\\ \begin{matrix}{Z}_{c} = \sqrt{{Z}_{T} {Z}_{p}} & ( 5 )\end{matrix}$$

Mitigation of reflective loss involves closely matching the impedance of the packaging material with that of the contained liquid. Although that solves the reflection problem at interface A in FIG. 1, the sample packaging material presents a whole different set of challenges. In general, acoustic impedance of materials range from near zero for gases to 45.6 Mrayls for steel. In terms of liquids, with the exception of mercury and gallium, the acoustic impedance is limited to under 3Mrayls. Hence a perfect impedance match between the sample, packaging material, and couplant liquid may be difficult to attain. As a result, packaging material with increased acoustic impedance is considered.

This disclosure provides the framework for mixing two or more miscible liquids until acceptable signal quality is obtained for the backwall reflection of a test sample (e.g., interface C in FIG. 1). The reflection from interface A is suppressed by a combination of lowered reflection loss due to lower impedance mismatch between couplant and packaging material and by increased attenuation of couplant. For a high attenuation couplant, reduction in the distance between the transducer and packaging material may be reduced accordingly for a higher signal to noise ratio. This facilitates automated filtering of relevant pulses by a simple amplitude (voltage) threshold filter or any other filtering technique for post processing using simple time domain analysis, phased array, synthetic aperture focusing technique, fast Fourier transform or wavelet-based analysis techniques.

In one aspect, the testing device comprises one or more transducers and is in electrical communication with a control unit.

In another aspect, the testing device is a non-destructive testing device, for example, an ultrasonic testing device.

In one aspect, the testing device comprises a packaging material, which may comprise polyurethane, polystyrene, polybutadiene, silicon, polyethylene, polypropylene, rubber, nylon, polycarbonate, acrylic, araldite, or any combination hereof.

A couplant may be a fluid, gel, or solid in liquid solution. It may also be a mixture of two or more miscible fluids, gels, or solid in liquid solutions (e.g. suspension) disposed in the housing. The couplant should have an acoustic impedance that is similar to the packaging material. The couplant may be water, glycerin, castor oil, ethylene glycol, kerosene, honey, glycerol, propylene glycol, sugar solution, solid liquid solution system, or any combination thereof.

For example, a packaging material is chosen to be polystyrene, which has an acoustic impedance of 2.3 Mrayls. The couplant disposed in the housing may be a mixture of water, which has an acoustic impedance of 1.48 Mrayls, and glycerin, which has an acoustic impedance of 2.43 Mrayls. For example a mixture containing 0% by weight glycerin in water, about 10% by weight glycerin, about 20% by weight glycerin, about 30% by weight glycerin, about 40% by weight glycerin, about 50% by weight glycerin, about 60% by weight glycerin, or 100% by weight glycerin may be used as the couplant in the housing.

It is considered that reflective losses may also occur at the interface of the packaging material and test sample. A second couplant may be applied to a dorsal end of the packaging material to minimize the reflective losses at the packaging material and test sample interface (e.g. interface B, FIG. 1) and to raise the attenuation levels. A second couplant may comprise the same or different two or more miscible fluids as the first couplant. In an example, the second couplant may be a fluid, gel or solid in liquid solutions (e.g. suspension) that is also present in the first couplant agent. For example, the second couplant may be glycerin.

In one aspect, the couplant disposed in the housing may be exchanged with the second couplant applied to the dorsal end of the packaging material.

In one aspect of the testing device, the acoustic reflection from the second surface of the test material (interface C, FIG. 1) is greater than about 30% of the magnitude of reflection from acoustic reflection from the first interface (interface A, FIG. 1). In yet other aspects, the acoustic reflection from the second surface of the test material is greater than about 40%, about 50%, about 60%, about 70%, about 80%, or about 90% of the magnitude of reflection from acoustic reflection from the first interface.

In another aspect, the acoustic reflection from the first interface is less than about 65% with respect to the reflection from second interface. In yet still other aspects, the acoustic reflection from the first interface is less than about 55%, about 45%, about 35%, about 25%, about 15%, or about 5% with respect to the reflection from second interface.

The above aspects may be achieved by the choice of couplants or the thickness of the packaging material. In some aspects, the thickness may be between about ½ and about % of the transmitted wavelength, between about ⅜ and about ¼ or between about ½ and about ⅜. In yet other aspects, the thickness of the packaging material is about 5/16 or about 7/16 of the transmitted wavelength. It is contemplated that the thickness of the material may be any multiple of the transmitted wavelength.

The testing device records the signal from all surfaces, and the testing device components (e.g. couplants, packaging material, thickness of packaging material) are chosen so that the signal to noise ratio of the second surface of the test material (surface C, FIG. 1) is improved by about 2 dB over a frequency range of 2.5×10⁵ Hz to about 2×10⁷ Hz, 1×10⁵ Hz to about 2×10⁷ Hz, 5×10⁶ Hz to about 2×10⁷ Hz, 1×10⁶ Hz to about 2×10⁷ Hz, 5×10⁷ Hz to about 2×10⁷ Hz, 4.5×10⁵ Hz to about 5×10⁷ Hz, 1×10⁵ Hz to about 5×10⁷ Hz, 5×10⁶ Hz to about 5×10⁷ Hz, 1×10⁶ Hz to about 5×10⁷ Hz, 4.5×10⁵ Hz to about 1×10⁶ Hz, 1×10⁵ Hz to about 1×10⁶ Hz, 5×10⁶ Hz to about 1×10⁶ Hz, 4.5×10⁵ Hz to about 5×10⁶ Hz, 1×10⁵ Hz to about 5×10⁶ Hz, or 4.5×10⁵ Hz to about 1×10⁵ Hz.

In particular, the signal to noise ratio of the second surface of the test material (interface C, FIG. 1) is improved by about 2 dB at a frequency of about 3×10⁵ Hz, about 2×10⁵ Hz, about 9×10⁶ Hz, about 8×10⁶ Hz, about 7×10⁶ Hz, about 6×10⁶ Hz, about 4×10⁶ Hz, about 3×10⁶ Hz, about 2×10⁶ Hz, about 9×10⁷ Hz, about 8×10⁷ Hz, about 7×10⁷ Hz, about 6×10⁷ Hz, about 4×10⁷ Hz, or about 3×10⁷ Hz.

In an exemplary method, the testing device as described above may be used to determine one or more properties of a test material with a predetermined thickness, wherein the testing material has a first surface and an opposite second surface.

In one aspect of the method, an acoustic signal transmitted by the test material is measured. In another aspect of the method, the acoustic signal reflected by the test material is measured.

In another aspect of the method, the testing device may exhibit an acoustic impedance mismatch of 45 Mega Rayls or less between an acoustic impedance of the first couplant agent and an acoustic impedance of the packaging material. In other aspects of the method, the acoustic impedance mismatch may be, for example, 40 Mega Rayls, 35 MRayls, 30 Mrayls, 25 Mrayls, 20 Mrayls, 15 Mrayls, 10 Mrayls, 9 Mrayls, 8 Mrayls, 7 Mrayls, 6 Mrayls, 5 Mrayls, 4 Mrayls, 3 Mrayls, 2 Mrayls, 1 Mrayls, 0.5 Mrayls or less.

In yet another aspect of the method, the ratio of two or more fluids or gels may be varied to achieve an acoustic impedance mismatch of 80% or less between an acoustic impedance of the first couplant agent and an acoustic impedance of the packaging material. In other aspects of the method, the two or more fluids or gels may be varied to achieve an acoustic impedance mismatch of, for example, 70%, 60%, 50%, 40%, 30%, 25%, 20%, 15%, 10%, 9%, 8%, 7%, 6%, 5%, 4%, 3%, 2%, 1%, or less.

The measured acoustic signal is then correlated with one or more properties of the test material, wherein the one or more properties measured may be defects, surface roughness, density estimate, speed of sound, temperature estimate, acoustic impedance estimate, time of flight, or any combination thereof.

### Examples

In a first study, variations of couplant contained in a device were designed to protect transducer from elements in its operating environment and maximize the signal throughput.

Materials and methods. The experimental setup consisted of a liquid column, of 6.5 cm length and 3 cm internal diameter, filled with deionized water. The dorsal end of the column was sealed off with a 1.5 cm PMMA block, which acts as the packaging material of the enclosed device. The packaging material was chosen for this desired experimental conditions. The fixed dimension of the device ensures localization of signals Aₛ and A_{d} in time and space for a given couplant solution.

FIG. 2 illustrates a typical case of sound interaction at interfaces A and B as shown in FIG. 1, for oblique signal incidence. Assuming normal incidence and constant temperature, the specific acoustic impedance (Z) denoted by a subscript for the respective medium is shown in FIG. 2. The signal-to-noise ratio at sample-packaging material interface (interface A, FIG. 1) was determined using Eq. 6 and at liquid couplant-packaging material interface (interface B, FIG. 1) using Eq. 7.

$$\\ \begin{matrix}20 {log}_{10} \frac{As}{Asw} & ( 6 )\end{matrix}$$

$$\\ \begin{matrix}20 {log}_{10} \frac{Ad}{Adw} & ( 7 )\end{matrix}$$

where, A_{sw} and A_{dw} are the reflection from PMMA-sample and couplant-PMMA interface when the couplant filled in the device was water.

The ratio of acoustic velocity was estimated as the ratios of time delay, per Eq. 8, assuming the distance traversed by the wave front in the couplant is constant.

$$\\ \begin{matrix}\frac{cs}{cw} = \frac{Δ tw}{Δ ts} & ( 8 )\end{matrix}$$

The time of flight (TOF) measurement of sound propagation in the sample was conducted simultaneously in the container of fixed dimension at room temperature and the velocity fraction with respect to DI water. Glycerin-DI water binary systems from 0 to 45% glycerin content by mass were subjected to acoustic reflection test as described previously. Under ideal circumstances of constant temperature and system invariability, Eq. 5 yields the reflection amplitude from PMMA-sample interface. The sample here was air maintained at room temperature of 24±1° C.

Signal Generation, Acquisition and Processing. The test apparatus consisted of a 2.25 MHz broadband Olympus V 306 transducer attached to a top end of the liquid column facing the induced defect. The element diameter was 12.7 mm and as a result the far field distance (F) was approximated to be 6.25 cm using Eq. 9.

$$\\ \begin{matrix}( F ) >= {D}^{{}_{} 2} f / ( 4 {V}_{p} ) & ( 9 )\end{matrix}$$

where, D is the element diameter, and f is the frequency.

Thus, far field approximation was possible using a 6.5 cm buffer column and ensured stability in signal while using the Multiple Reflection Method (MRM). Olympus 5072PR pulser receiver was connected to the transducer using a 50Ω BNC cable and the pulser receiver was also connected to a Tektronix MSO 2024B Oscilloscope using 50Ω cable.

Sampling was conducted at a frequency of 0.5 GHz compliant with Nyquist frequency requirements. Additionally, high temporal resolution improved accuracy in amplitude determination as per prior studies. The signal received was subjected to averaging and further the signal was truncated with 1500 bits on either side of the maxima. The resultant three wave forms were subjected to an Fast Fourier Transform (FFT) algorithm, followed by a Full Wave Quarter Modulus (FWQM) filter. In general, amplitude (A) obtained from any interface (referenced using subscript used in Eqs. 6-7) was obtained using Eq. 10.

$$\\ \begin{matrix}{A}_{x} = {\sum }_{0}^{2048} {a}_{i} & ( 10 )\end{matrix}$$

FWQM was chosen in this study under the presumption that any octave choice may be used as long as noise is filtered out. Amplitude of reflection from interface B rose with the amplitude of the respective incident wave. A corresponding rise in transmitted wave was expected due to the conservation of energy.³⁷

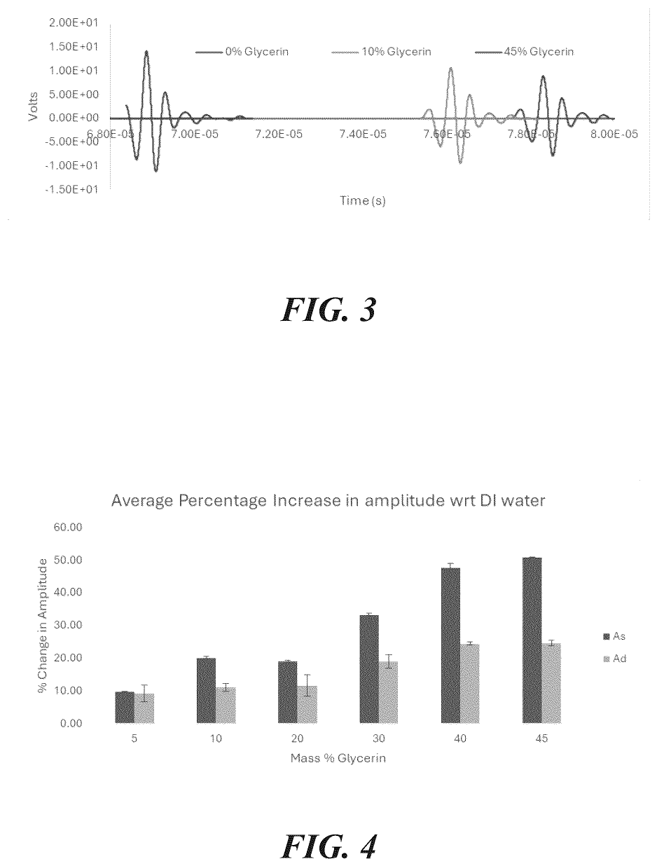

Results and Discussion. The reflections, Aₛ, were plotted in the time domain for couplants containing 0%, 10%, and 45% glycerin, respectively. FIG. 3 illustrates the improvement in signal due to the variation in couplant proportions.

It was observed that there was an increase in Aₛ in the time domain, as shown in FIG. 3. Additionally, the amplitude increased in both Aₛ and A_{d}. The amplitudes from interfaces A and B were compared side by side as a percentage with respect to corresponding A_{sw} and A_{dw} using DI water as the couplant.

Both Aₛ and A_{d} rose as the mass percentage of glycerin in the couplant increased, as shown in FIG. 4. The rate of increase in Aₛ was greater than the rate of increase in A_{d}. The rise in A_{d} was attributed to the improved acoustic impedance between the transducer matching layer and the couplant. While the additional increase in Aₛ was attributed to the improvement in the impedance matching at interface A in FIG. 1. The rise in Aₛ was attributed to increased incident intensity, as a result a similar increase was observed in transmitted signal T, FIG. 2, from interface B of FIG. 1.

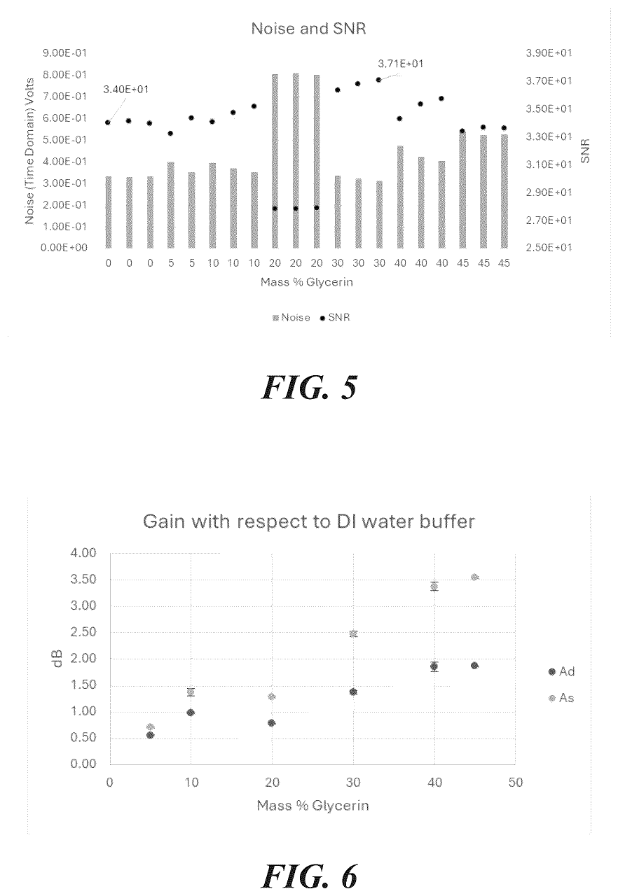

In FIG. 5, the noise attributed to Aₛ and the signal to noise ratio (SNR) is plotted for various measurements at 0 to 45% glycerin-water mixture. The trends reveal a general rise in SNR despite a nearly constant noise value.

An improvement of 0.31 dB was observed at 30% glycerin content. Additionally, the gain in Aₛ with respect to A_{sw}, i.e. Aₛ using DI water as the couplant, is plotted in FIG. 6. It can be inferred from FIG. 6 that a 3.57 dB improvement in Aₛ was achieved using 45% glycerin by mass. At 20% and above 40% glycerin content in the couplant, however, a drop in gain was observed compared to 10% glycerin content, which was attributed to the higher noise levels seen in FIG. 5. The effect of impedance matching and that of attenuation were not isolated. The design of mixtures of higher acoustic impedance increased the reflection from the dorsal end, equivalent to doubling the amplifier power input. The attenuation of couplant varied with increasing proportion of glycerin, however no ill effects were observed in signal quality due to this effect or on bandwidth, which improved slightly as seen in FIG. 8.

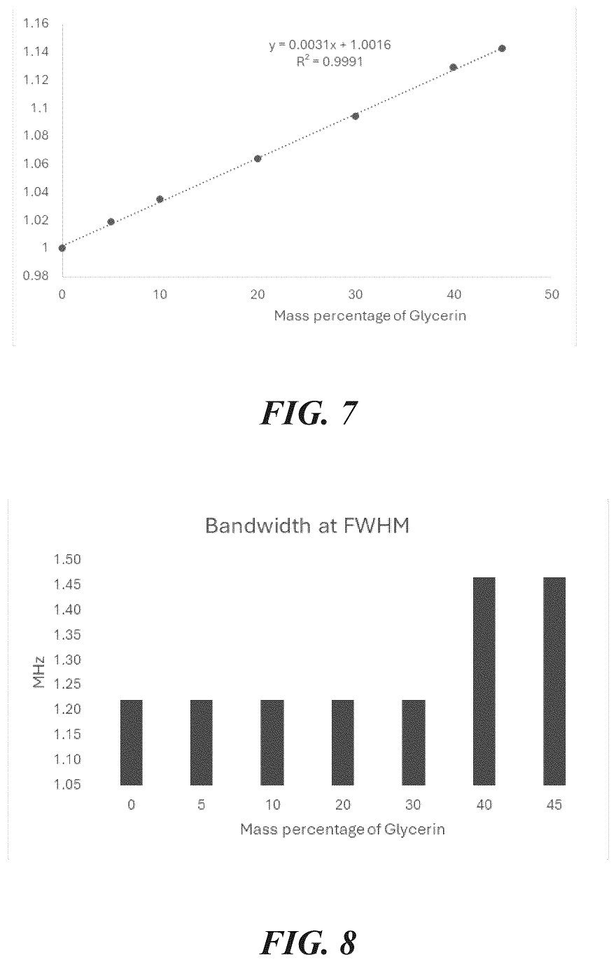

The ratio of speed of sound of couplant to that of DI water is plotted in FIG. 7. A steady rise was observed up to 45% glycerin content by mass in the couplant.

Glycerin water mixtures are traditionally used as anti-freeze.³⁸⁻⁴⁰ The addition of corrosion inhibitors such as carboxylate or other positive inorganic salt along with defoamer such as tributyl phosphate (TiBP) reduced the chances of corrosion by hindering the corrosion mechanism in metals as depriving the couplant of dissolved and entrained air. Additionally, in applications where the enclosed device was placed in a hot environment, the couplant mixture can be circulated through a heat exchanger to be cooled and recirculated due to its high heat carrying capacity. Additionally, should the device be operating at temperatures below 0° C., the antifreeze will extend the device functionality by lowering the freezing point.

Lowering the effect of electrical conductivity in glycerin-water mixtures with increasing glycerin content provides improved electrical insulation for the transducer/transducers in the device preventing current leakages and cross talk.^{41,42}

An additional use for this technology includes creating robust housing for transducers employed in harsh and/or corrosive environments. For instance, underwater transducers may be housed in a material, plastic or otherwise, to match the acoustic impedance of salt water at the depth of operation, By varying the proportion of couplant contained in the housing along with transducer and other components one can easily minimize the reflective losses due to the packaging material.

Conclusion. This study investigated the possibility of an enclosure for immersion transducer with carefully selected packaging materials that may be dictated by the environment in which it is deployed, usually for protection of Piezo electric transducers or others from destructive environmental elements. By using a mixture of miscible liquid systems or solid-liquid solutions and appropriate corrosion inhibitors, the acoustic impedance of the couplant was modified to mitigate its impedance disparity with both transducer matching layer as well as the packaging material enclosing the couplant, transducer and/or the circuits. As a result, the throughput of signal is improved up to 50% at the sample-device interface. The SNR was improved by varying the couplant mixture composition. The bandwidth was improved by varying the mixture ratio of couplant in the enclosed device. The range of operation of transducer was improved by lowering the freezing point of the couplant. A safe operating condition was ensured for optimal operation of the transducer by making it possible to recirculate the couplant through a heat exchanger for cooling, extending the operating temperature range further by either heating or cooling.

The use of glycerin as an adulterant is illustrated herein. Any other set of miscible liquids may be used to achieve an improvement in transmitted signal. For example, suspension or colloidal dispersion such as slilica fume, polycarboxylate, xantan gum or starch may be used instead of two miscible liquids. It is contemplated that a suitable suspension includes particles that are much smaller than the wavelength of propagation of sound in the couplant, preventing losses due to scattering and the attenuative losses do not deteriorate the signal strength or quality. In some aspects, the couplant blend used inside the device can also be applied to the exterior of packaging material when the sample of interest was in a solid phase.

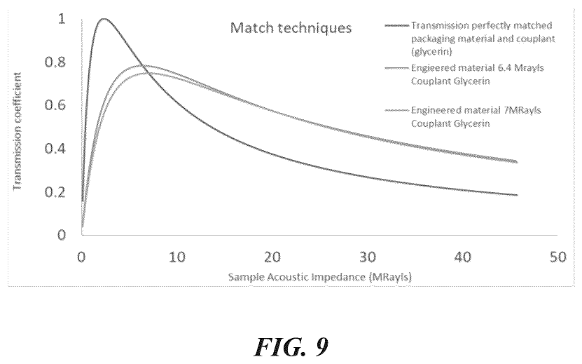

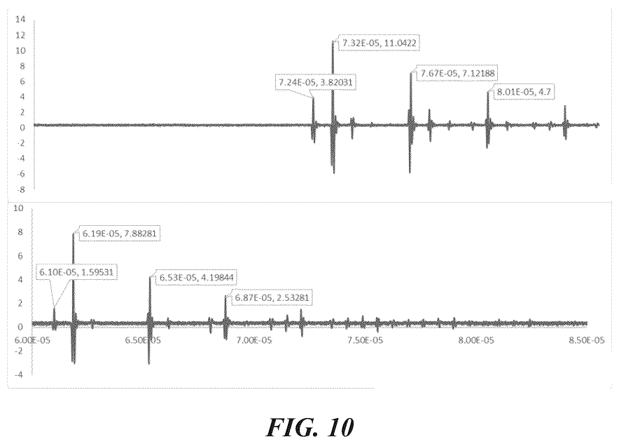

In a second study, FIG. 9 shows a comparison of various packaging material with glycerin couplant. Consider the use of glycerin as couplant, a high acoustic impedance material among liquids. When perfectly matched with polystyrene with similar acoustic impedance of 2.33 Mrayls and assuming a normal incidence, the transmission factor declines rapidly after the sample acoustic impedance of 2.33 Mrayls for the sample as opposed to a slower decline for engineered material of 6.4 Mrayls or higher with the same couplant. This demonstrates the capability of engineered materials equipped to provide a high signal to noise ratio as opposed to the conventional packaging material, provided it can attain significant contact with the sample for a wider range of samples.

Due to the dispersive nature of the medium, acoustic signal loses energy as well as is distorted by the medium. This is a material property and has immense effect on the signal amplitude as well as quality. For the packaging material it may be controlled during design.

In the previous example, as shown in FIG. 9, where glycerin was used as the couplant, the attenuation factor was expressed as the log-ratio of the amplitudes and was quite large in comparison to water. However, when water was used as the couplant, the reflection from interface A per FIG. 1 and its echoes were more pronounced, which makes it difficult to distinguish between the signal from sample surfaces especially when the task is automated. On the other hand, the signal quality was lowered significantly when glycerin alone was used as a couplant, however reflections from surface A and associated echoes are suppressed when glycerin was used as the couplant and polystyrene as packaging material.

In the following examples, the following materials and equipment were used: Olympus 5072PR pulse receiver, MSO 2024B Olympus oscilloscope, V312 10 MHz transducer.

For experiment A, the arrangement was per FIG. 1, the transducer was connected to the pulse receiver in pulse echo mode, the output was collected using the oscilloscope wired to the pulse receiver. The couplant inside the device was water with acoustic impedance of 1.48 Mrayls. The packaging material was polystyrene with acoustic impedance 2.3 Mrayls. A layer of glycerin (of acoustic impedance 2.43 Mrayls), perfectly matched to polystyrene, was applied on interface B to establish signal transmission into the sample. The sample was an acrylic mass of 1 cm thickness and contained a defect nearly at the center. The signal obtained is differentiated as per the material interfaces marked in FIG. 10, “Experiment A”.

For experiment B, the arrangement was per FIG. 1, the transducer was connected to the pulse receiver in pulse echo mode, the output was collected using the oscilloscope wired to the pulse receiver. The couplant inside the device was replaced with glycerin-water solution having a 4:3 ratio by weight and acoustic impedance greater than 1.5 Mrayls. The packaging material was polystyrene having an acoustic impedance 2.3 Mrayls. A layer of glycerin (of acoustic impedance 2.43 Mrayls), perfectly matched to polystyrene, was applied on interface B to establish signal transmission into sample. The sample was an acrylic mass of 1 cm thickness having a defect nearly at the center. The signal obtained was differentiated as per the material interfaces marked in FIG. 10, “Experiment B”.

The signal output was plotted against time. At first glance, the number of reflections was significantly reduced owing to closer match at interface A as well as the increased attenuation of the coupling medium. Upon closer observation, it was evident that the amplitude of all reflections decreases. This may be attributed to the slight variation in angle of incidence or the attenuation. The ratio of highest amplitude for reflection from interface C and interface A was calculated in both cases, and the results are listed in Table 1.

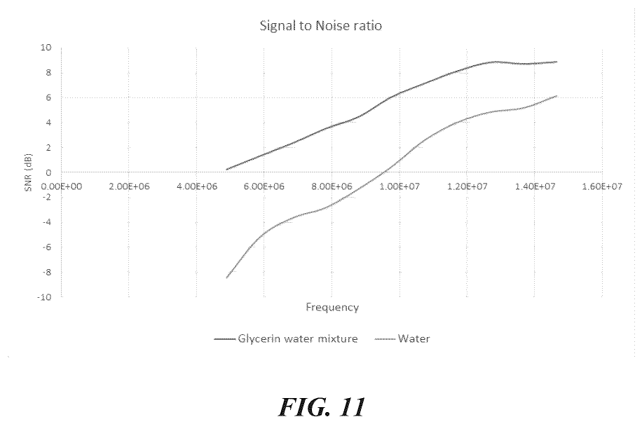

The signal-to-noise ratio (SNR) is calculated using the following formula:

$$\\ SNR = 20 {log}_{10} ( \frac{{A}_{RC}}{{A}_{RA}} )$$

Where, A_{RA} is the amplitude in frequency domain of reflection from interface A and A_{RC} the amplitude in frequency domain of reflection from interface C. The resulting SNR from the experiments are shown in FIG. 11.

TABLE 1
Back wall reflection to couplant packaging material
interface reflection amplitude comparison.

| | R_{C} (mV) | R_{A} (mV) | R_{C}/R_{A} |
|---|---|---|---|
| Experiment A | 4.7 | 3.82031 | 1.230267 |
| Experiment B | 2.53281 | 1.59531 | 1.58766 |

From the result it was evident that a higher signal to noise ratio was obtained when a mixture of glycerin and water was used as opposed to just water. Additionally, miscible liquids such as honey, water, glycerin, glycerol, propylene glycol or oil-based organic solvents can be exploited to minimize the reflective losses at the packaging material-couplant interface or simply to raise the attenuation levels for the ease of signal differentiation. At higher acoustic impedance, the dependency on attenuation of couplant becomes a reliable technique to suppress unnecessary echoes from the package material interfaces with couplant and sample adding to the ease of signal processing.

### EXEMPLARY ASPECTS

Exemplary aspect 1: A testing device comprising a housing comprising: a first couplant agent and a transducer, wherein the housing has a proximal end and a distal end; a packaging material having a proximal end and a distal end, wherein the proximal end of the packaging material is coupled to the distal end of the housing to form a first interface; wherein the distal end of the packaging material is configured to be in communication with a test material, wherein the test material has a predetermined thickness defined by a first surface and an opposite second surface, and wherein a second interface is formed between the first surface of the test material and the distal end of the packaging material during testing, wherein an acoustic impedance mismatch between the first couplant agent and the packaging material is less than or equal to the acoustic impedance mismatch between packaging material and test material.

Exemplary aspect 2: The testing device of any exemplary aspect herein, particularly example 1, further comprising a second couplant agent applied to the distal end of the packaging material during testing such that it is disposed at the second interface.

Exemplary aspect 3: The testing device of any exemplary aspect herein, particularly example 1 or 2, wherein the first couplant agent is a fluid, a gel, or a solid in liquid solution (e.g. suspension).

Exemplary aspect 4: The testing device of any exemplary aspect herein, particularly examples 1-3, wherein the first couplant agent is a mixture of two or more fluids, gels, or solid in liquid solutions.

Exemplary aspect 5: The testing device of any exemplary aspect herein, particularly example 4, wherein a ratio of two or more fluids, gels, or solid in liquid solutions is varied.

Exemplary aspect 6: The testing device of any example herein, particularly examples 2-5, wherein the second couplant agent is the same or different from the first couplant agent.

Exemplary aspect 7: The testing device of any exemplary aspect herein, particularly examples 4-6, wherein the second couplant agent comprises at least one of the two or more fluids, gels, or solid in liquid solutions (e.g. suspension) present in the first couplant agent.

Exemplary aspect 8: The testing device of any exemplary aspect herein, particularly examples 2-7, wherein the second couplant agent has an acoustic impedance substantially identical to an acoustic impedance of the packaging material.

Exemplary aspect 9: The testing device of any exemplary aspect herein, particularly examples 1-8, wherein an acoustic reflection from the first interface is less than about 65 percent with respect to the reflection from the second interface.

Exemplary aspect 10: The testing device of any exemplary aspect herein, particularly examples 1-9, wherein an acoustic reflection from the second surface of the test material is less than about 65 percent with respect to the reflection from the second interface.

Exemplary aspect 11: The testing device of any exemplary aspect herein, particularly examples 1-10, wherein the packaging material has a thickness of about ½ to about ¼ of a transmitted wavelength.

Exemplary aspect 12: The testing device of any exemplary aspect herein, particularly examples 1-11, wherein the packaging material comprises polyurethane, polystyrene, polybutadiene, silicon, polyethylene, polypropylene, rubber, nylon, polycarbonate, acrylic, araldite, or any combination thereof.

Exemplary aspect 13: The testing device of any exemplary aspect herein, particularly examples 1-12, wherein the first couplant agent comprises water, glycerin, castor oil, ethylene glycol, kerosene, honey, glycerol, propylene glycol, sugar solution, solid liquid solution system, or any combination thereof.

Exemplary aspect 14: The testing device of any exemplary aspect herein, particularly examples 1-13, wherein a signal from the second surface of the test material has a signal-to-noise ratio of greater than about 2 dB over a frequency range of about 4.5×10⁵ Hz to about 2×10⁷ Hz.

Exemplary aspect 15: The testing device of any example herein, particularly examples 1-14, wherein the first and/or second couplant agents are exchangeable.

Exemplary aspect 16: The testing device of any exemplary aspect herein, particularly examples 1-15, wherein the transducer comprises one or more transducers.

Exemplary aspect 17: The testing device of any exemplary aspect herein, particularly examples 1-16, wherein the testing device is in electrical communication with a control unit.

Exemplary aspect 18: The testing device of any exemplary aspect herein, particularly examples 1-17, wherein the test material comprises a metal, a liquid, a gel, a polymer, a concrete, or any combination thereof.

Exemplary aspect 19: The testing device of any exemplary aspect herein, particularly examples 1-18, wherein the testing device is a non-destructive testing device.

Exemplary aspect 20: A method of determining one or more properties of a test material, wherein the method comprises: contacting a testing device comprising: a housing comprising a first couplant agent and a transducer, wherein the housing has a proximal end and a distal end; a packaging material having a proximal end and a distal end, wherein the proximal end of the packaging material is coupled to the distal end of the housing to form a first interface; with a test material, wherein the test material has a predetermined thickness defined by a first surface and an opposite second surface; such that a second interface is formed between the first surface of the test material and the distal end of the packaging material; measuring an acoustic signal transmitted/reflected by the test material; and correlating the acoustic signal with the one or more properties of the test material.

Exemplary aspect 21: The method of any exemplary aspect herein, particularly example 20, wherein the testing device exhibits an acoustic impedance mismatch of 45 Mega Rayls or less between an acoustic impedance of the first couplant agent and an acoustic impedance of the packaging material.

Exemplary aspect 22: The method of any exemplary aspect herein, particularly example 20 or 21, wherein the first couplant agent is a fluid or a gel.

Exemplary aspect 23: The method of any exemplary aspect herein, particularly examples 20-22, wherein the first couplant agent is a mixture of two or more fluids, gels, or solid in liquid solutions.

Exemplary aspect 24: The method of any exemplary aspect herein, particularly example 23, wherein the method comprises varying a ratio of two or more fluids or gels to achieve an acoustic impedance mismatch of 30% or less between an acoustic impedance of the first couplant agent and an acoustic impedance of the packaging material.

Exemplary aspect 25: The method of any exemplary aspect herein, particularly examples 20-24, further comprising applying a second couplant at the distal end of the packaging material to form a layer of the second couplant at the second interface.

Exemplary aspect 26: The method of any exemplary aspect herein, particularly examples 25, wherein the second couplant agent is the same or different from the first couplant agent.

Exemplary aspect 27: The method of any exemplary aspect herein, particularly examples 25-26, wherein the second couplant agent comprises at least one of the two or more fluids, gels, or solid in liquid solutions (e.g. suspension) present in the first couplant agent.

Exemplary aspect 28: The method of any exemplary aspect herein, particularly examples 25-27, wherein the second couplant agent has an acoustic impedance substantially identical to an acoustic impedance of the packaging material.

Exemplary aspect 29: The method of any exemplary aspect herein, particularly examples 20-28, wherein an acoustic reflection from the first interface is less than about 65% with respect to the reflection from sample device interface.

Exemplary aspect 30: The method of any exemplary aspect herein, particularly examples 20-29, wherein an acoustic reflection from the from the second surface of the test material is greater than about 30% of a magnitude of reflection from acoustic reflection from the first interface.

Exemplary aspect 31: The method of any exemplary aspect herein, particularly examples 20-30, wherein the packaging material has of thickness of about ½ to about ¼ of a transmitted wavelength.

Exemplary aspect 32: The method of any exemplary aspect herein, particularly examples 20-31, wherein the packaging material comprises polyurethane, polystyrene, polybutadiene, silicon, polyethylene, polypropylene, rubber, nylon, polycarbonate, acrylic, araldite, or any combination thereof.

Exemplary aspect 33: The method of any exemplary aspect herein, particularly examples 20-32, wherein the first couplant agent comprises water, glycerin, castor oil, ethylene glycol, kerosene, honey, glycerol, propylene glycol, sugar solution, solid liquid solution system, or any combination thereof.

Exemplary aspect 34: The method of any exemplary aspect herein, particularly examples 20-33, wherein a signal from the second surface of the test material has a signal-to-noise ratio of greater than about 2 dB over a frequency range of about 4.5×10⁵ Hz to about 2×10⁷ Hz.

Exemplary aspect 35: The method of any exemplary aspect herein, particularly examples 20-34, wherein the transducer comprises one or more transducers.

Exemplary aspect 36: The method of any exemplary aspect herein, particularly examples 20-35, wherein the one or more properties comprise defects, surface roughness, density estimate, speed of sound, temperature estimate, acoustic impedance estimate, time of flight, or any combination thereof.

### REFERENCES

[1] Hossain, M. S., Pal, B., & Mukhopadhyay, P. K. (2018). Ultrasonic Characterization of Newtonian and Non-newtonian Fluids. Universal Journal of Physics and Application, 12(3), 41-46.
1. Yadav K, Yadav S, Dubey P K. A Comparative Study of Ultrasonic Contact and Immersion Method for Dimensional Measurements. MAPAN 2021; 36: 319-324.
2. Xu Y, Zhu K, Sun E, et al. Wide-bandwidth immersion ultrasound transducer made of Mn:PIMNT single crystal/epoxy 1-3 composite. Sens Actuators A Phys 2024; 369: 115196.
3. Zhang Y, Qin Z, Luo S, et al. Design and Application of Partial Immersion Focused Ultrasonic Transducers for Austenitic Weld Inspection. Sensors 2022; 22: 2671.
4. Zhang J, Cho Y, Kim J, et al. Non-Destructive Evaluation of Coating Thickness Using Water Immersion Ultrasonic Testing. Coatings 2021; 11: 1421.
5. Joseph J, Ma B, Khuri-Yakub B T. Applications of Capacitive Micromachined Ultrasonic Transducers: A Comprehensive Review. IEEE Trans Ultrason Ferroelectr Freq Control 2022; 69: 456-467.
6. Rathod V T. A Review of Acoustic Impedance Matching Techniques for Piezoelectric Sensors and Transducers. Sensors 2020; 20: 4051.
7. Poelma C. Ultrasound Imaging Velocimetry: a review. Exp Fluids 2017; 58: 3.
8. Bhat G A, Jasiuniene E. Evaluation of Artificial Defects in Additively Manufactured Turbine Blade using Ultrasonic Immersion Testing, http://www.ndt.net/?id=26402 (2021).
9. Bhat G A, Jasiuniene E. Evaluation of Artificial Defects in Additively Manufactured Turbine Blade using Ultrasonic Immersion Testing, http://www.ndt.net/?id=26402 (2021).
10. Yilmaz B, Ba A, Jasiuniene E, et al. Evaluation of Bonding Quality with Advanced Nondestructive Testing (NDT) and Data Fusion. Sensors 2020; 20: 5127.
11. Ming D, Hui T, Hong-Wei M, et al. Acoustic field simulation-based ultrasonic water immersion non-destructive testing for titanium alloy plate. Nondestructive Testing and Evaluation 2024; 1-14.
12. Rey M, Hertzog I, Kagami N, et al. Blind Guardian: A Sonar-Based Solution for Avoiding Collisions with the Real World. In: 2015 XVII Symposium on Virtual and Augmented Reality. IEEE, 2015, pp. 237-244.
13. Bennaceur I, Cristol X, Docquois R, et al. Target Localization in Depth and Range from Passive Sonar. In: OCEANS 2018 MTS/IEEE Charleston. IEEE, 2018, pp. 1-9.
14. Marage J-P, Mori Y. Sonar and Underwater Acoustics. 2010.
15. Stevens A H, Butkiewicz T. Faster Multibeam Sonar Data Cleaning: Evaluation of Editing 3D Point Clouds using Immersive VR. In: OCEANS 2019 MTS/IEEE SEATTLE. IEEE, 2019, pp. 1-10.
16. Mours A, Mars J I, Ioana C, et al. Range, velocity and immersion estimation of a moving target in a water-filled tank with an active sonar system. In: OCEANS 2015—Genova. IEEE, 2015, pp. 1-6.
17. Corbin J, Lakin J M, Akula S, et al. Navy STEM Challenges: Innovative Labs and Activities with SONAR. In: 2023 IEEE Frontiers in Education Conference (FIE). IEEE, 2023, pp. 1-4.
18. Castellano A, Foti P, Fraddosio A, et al. Ultrasonic immersion tests for mechanical characterization of multilayered anisotropic materials. In: 2014 IEEE Workshop on Environmental, Energy, and Structural Monitoring Systems Proceedings. IEEE, 2014, pp. 1-6.
19. Castellano A, Foti P, Fraddosio A, et al. Characterization of Material Damage by Ultrasonic Immersion Test. Procedia Eng 2015; 109: 395-402.
20. Castellano A, Foti P, Fraddosio A, et al. Mechanical characterization of CFRP composites by ultrasonic immersion tests: Experimental and numerical approaches. Compos B Eng 2014; 66: 299-310.
21. Yilmaz B, Asokkumar A, Jasiūniené E, et al. Air-Coupled, Contact, and Immersion Ultrasonic Non-Destructive Testing: Comparison for Bonding Quality Evaluation. Applied Sciences 2020; 10: 6757.
22. Fei C, Ma J, Chiu C T, et al. Design of matching layers for high-frequency ultrasonic transducers. Appl Phys Lett; 107. Epub ahead of print 21 Sep. 2015. DOI: 10.1063/1.4931703.
23. Callens D, Bruneel C, Assaad J. Matching ultrasonic transducer using two matching layers where one of them is glue. NDT & E International 2004; 37: 591-596.
24. Liu Q-H, Tao J. The perfectly matched layer for acoustic waves in absorptive media. J Acoust Soc Am 1997; 102: 2072-2082.
25. Hadimioglu B, Khuri-Yakub B T. Polymer films as acoustic matching layers. In: IEEE Symposium on Ultrasonics. IEEE, pp. 1337-1340.
26. Saffar S, Abdullah A. Determination of acoustic impedances of multi matching layers for narrowband ultrasonic airborne transducers at frequencies &lt;2.5 MHz—Application of a genetic algorithm. Ultrasonics 2012; 52: 169-185.
27. Bian J, Wang Y, Liu Z, et al. Ultra-wideband underwater acoustic transducer with a gradient impedance matching layer. Applied Acoustics 2021; 175: 107789.
28. Elliott A S, Venegas R, Groby J P, et al. Omnidirectional acoustic absorber with a porous core and a metamaterial matching layer. J Appl Phys; 115. Epub ahead of print 28 May 2014. DOI: 10.1063/1.4876119.
29. Ji H, Qi A, Yang F, et al. Design of acoustic impedance gradient matching layers. Applied Acoustics 2023; 211: 109549.
30. Haller M I, Khuri-Yakub B T. Tapered acoustic matching layers. In: 1993 Proceedings IEEE Ultrasonics Symposium. IEEE, 1993, pp. 505-508 vol. 1.
31. Zhang Z, Yang L, Wang X, et al. Synergistic Enhancement of Bandwidth and Sensitivity of Phased Array Ultrasonic Transducer With Novel Acoustic Mismatch Structure. IEEE Trans Instrum Meas 2024; 73: 1-7.
32. Guan S, Wang X, Hua L, et al. Ultrasonic phased array inspection of aeroengine casing ring forgings using adaptive filtering and angle gain compensation algorithm. Applied Acoustics 2022; 195: 108833.
33. Desilets C S, Fraser J D, Kino G S. The design of efficient broad-band piezoelectric transducers. IEEE Trans Sonics Ultrason 1978; 25: 115-125.
34. Rhee S, Ritter T A, Shung K K, et al. Materials for acoustic matching in ultrasound transducers. In: 2001 IEEE Ultrasonics Symposium. Proceedings. An International Symposium (Cat. No. 01CH37263). IEEE, pp. 1051-1055.
35. Bakhtiari-Nejad M, Hajj M R, Shahab S. Dynamics of acoustic impedance matching layers in contactless ultrasonic power transfer systems. Smart Mater Struct 2020; 29: 035037.
36. Qu S, Gao N, Tinel A, et al. Underwater metamaterial absorber with impedance-matched composite. Sci Adv; 8. Epub ahead of print 20 May 2022. DOI: 10.1126/sciadv.abm4206.
37. Schmerr L W. Springer Series in Measurement Science and Technology Fundamentals of Ultrasonic Nondestructive Evaluation A Modeling Approach Second Edition, http://www.springer.com/series/13337.
38. Regis Joseph P, Paul Otto F, Leonard Sherman Bartley Jr. United States Pate U.S. Ser. No. 00/738,7748B2, https://patents.google.com/patent/U.S. Pat. No. 7,387,748B2/en (accessed 31 Mar. 2024).
39. YANG B, WOYCIESJES P M. EP1809718B1;International application number: PCT/US2005/031834, https://patents.google.com/patent/EP1809718B1/en?oq=EP1809718B1;lnternatio nal+application+number:+PCT %2fUS2005%2f031834 (accessed 31 Mar. 2024).
40. Douglas Hudgens R, Hercamp R D, Francis J, et al. An Evaluation of Glycerin (Glycerol) as a Heavy Duty Engine Antifreeze/Coolant Base, https://about.jstor.org/terms (2007).
41. Meaney P M, Fox C J, Geimer S D, et al. Electrical Characterization of Glycerin: Water Mixtures: Implications for Use as a Coupling Medium in Microwave Tomography. IEEE Trans Microw Theory Tech 2017; 65:1471-1478.
42. Ali N M, Kareem A A, Polu A R. Effect of Glycerin on Electrical and Thermal Properties of PVA/Copper Sulphate Gel Polymer Electrolytes. J Inorg Organomet Polym Mater 2022; 32: 4070-4076.

What is claimed is:

1. A testing device comprising:
a housing comprising a first couplant agent and a transducer, wherein the housing has a proximal end and a distal end; and
a packaging material having a proximal end and a distal end, wherein the proximal end of the packaging material is coupled to the distal end of the housing to form a first interface;
wherein the test material has a first surface and an opposite second surface;
wherein a second interface is formed between the first surface of the test material and the distal end of the packaging material during testing; and
wherein an acoustic impedance mismatch between the first couplant agent and the packaging material is less than or equal to an acoustic impedance mismatch between packaging material and test material.

2. The testing device of claim 1, wherein the first couplant agent comprises water, glycerin, castor oil, ethylene glycol, kerosene, honey, glycerol, propylene glycol, sugar solution, solid liquid solution system, or a combination thereof.

3. The testing device of claim 1, wherein the first couplant agent is a mixture of two or more fluids, gels, or solid in liquid solutions.

4. The testing device of claim 3, wherein a ratio of two or more fluids, gels, or solid in liquid solutions is varied.

5. The testing device of claim 3, further comprising a second couplant agent applied to the distal end of the packaging material during testing such that it is disposed at the second interface.

6. The testing device of claim 5, wherein the second couplant agent comprises at least one of the two or more fluids, gels, or solid in liquid solutions present in the first couplant agent.

7. The testing device of claim 5, wherein the second couplant agent has an acoustic impedance substantially identical to an acoustic impedance of the packaging material.

8. The testing device of claim 1, wherein an acoustic reflection from the first interface is less than about 65 percent with respect to the reflection from the second interface.

9. The testing device of claim 1, wherein the packaging material has a thickness of about ½ to about ¼ of a transmitted wavelength or any multiple thereof.

10. The testing device of claim 1, wherein the packaging material comprises polyurethane, polystyrene, polybutadiene, silicon, polyethylene, polypropylene, rubber, nylon, polycarbonate, acrylic, araldite, or any combination thereof.

11. The testing device of claim 5, wherein the first couplant agents and second couplant agents are exchangeable.

12. The testing device of claim 1, wherein the testing device is in electrical communication with a control unit.

13. The testing device of claim 1, wherein the test material comprises a metal, a liquid, a gel, a polymer, a concrete, or any combination thereof.

14. The testing device of claim 1, comprising two or more transducers.

15. A method of determining one or more properties of a test material, wherein the method comprises:
a) contacting a testing device, the testing device comprising:
i) a housing comprising a first couplant agent and a transducer, wherein the housing has a proximal end and a distal end;
ii) a packaging material having a proximal end and a distal end, wherein the proximal end of the packaging material is coupled to the distal end of the housing to form a first interface;
wherein the test material has a first surface and an opposite second surface, such that a second interface is formed between the first surface of the test material and the distal end of the packaging material;
b) measuring an acoustic signal transmitted or reflected by the test material; and
c) correlating the acoustic signal with the one or more properties of the test material.

16. The method of claim 15, wherein the testing device exhibits an acoustic impedance mismatch of 45 Mega Rayls or less between an acoustic impedance of the first couplant agent and an acoustic impedance of the packaging material.

17. The method of claim 15, wherein the first couplant agent is a mixture of two or more fluids, gels, or solid in liquid solutions.

18. The method of claim 17, further comprising varying a ratio of two or more fluids, gels, or solid in liquid solutions to achieve an acoustic impedance mismatch of 30% between an acoustic impedance of the first couplant agent and an acoustic impedance of the packaging material.

19. The method of claim 17, further comprising applying a second couplant agent at the distal end of the packaging material to form a layer of the second couplant agent at the second interface.

20. The method of claim 19, wherein the second couplant agent comprises at least one of the two or more fluids, gels, or solid in liquid solutions of the first couplant agent.

21. The method of claim 19, wherein the second couplant agent has an acoustic impedance substantially identical to an acoustic impedance of the packaging material.

22. The method of claim 15, wherein an acoustic reflection from the first interface is less than about 65% with respect to the reflection from sample device interface, and wherein an acoustic reflection from the second surface of the test material is greater than about 30% of a magnitude of reflection from acoustic reflection from the first interface.

23. The method of claim 15, wherein the one or more properties comprise defects, surface roughness, density estimate, speed of sound, temperature estimate, acoustic impedance estimate, time of flight, or any combination thereof.

24. The method of claim 15, wherein contacting a testing device comprises contacting two or more testing devices.
